(19) United States
(12) Patent Application Publication
(10) Pub. No.: US 2013/0327956 A1
(43) Pub. Date: Dec. 12, 2013

(54) PHOSPHOR LAYER DETECTION SYSTEM

(71) Applicants: Peiching Ling, San Jose, CA (US); Dezhong Liu, Santa Clara, CA (US)

(72) Inventors: Peiching Ling, San Jose, CA (US); Dezhong Liu, Santa Clara, CA (US)

(73) Assignee: ACHROLUX INC., San Jose, CA (US)

(21) Appl. No.: 13/490,642

(22) Filed: Jun. 7, 2012

(51) Int. Cl. G01N 21/64

(52) U.S. Cl. 250/458.1; 250/206

(57) ABSTRACT

A detection system for detecting a fluorescent layer formed in a fluorescent layer forming system is disclosed. The detection system of the present invention includes a light source module, a light detecting module and a light transmitting module, wherein the light source module emits a detecting light to a fluorescent layer, the detecting light is then converted by the fluorescent layer to a light to be detected, the light to be detected is received by the light detecting module, and detection data are formed. A control instruction is transmitted to the fluorescent layer forming system according to the control instruction to control the fluorescent layer forming system, such that a desired fluorescent layer is formed on an object, and optical property of fluorescent layers in each fabrication is consistent.

### FIELD OF INVENTION

The present invention relates to a detection technology, and more particularly, to a detection system for detecting a formation status of a fluorescent layer in a fluorescent layer forming system.

### BACKGROUND OF THE INVENTION

In a light emitting diode (LED), a fluorescent material is used for converting the wavelength emitted from the LED into a color light.

In the conventional fabrication of an LED package, a fluorescent material is packaged and dispersed in a light transmitting body as shown in FIG. 1, wherein the LED package includes an LED chip 100 and a light transmitting body 300, and a fluorescent material is dispersed in the light transmitting body 300. After the light 400 emits from the LED chip 100, the light wavelength of the light 400 is converted by fluorescent particles 200. For example, the light 400 emitting from the LED chip 100 is blue light, converted by yellow fluorescent particles 200, and then emitted from the LED package as white light. The conventional fluorescent particles 200 are dispersed in a silicon resin to form a light transmitting body 300. However, the distribution of the fluorescent particles 200 cannot be controlled in the prior art, such that the color of light converted from the LED is not even. The optical property is inconsistent in each fabrication of LEDs, and thus the reliability of the fabrication of LEDs is poor.

There is another fabrication method to overcome the above-mentioned drawbacks in the prior art. As shown in FIG. 2, an LED package is similar to that in FIG. 1 except that the fluorescent layer 200′ is formed by electrostatic attraction, such that the fluorescent layer 200′ is more even. However, there is still a problem that the optical property and the color of light are inconsistent in each fabrication of LEDs.

Hence, there is a need to develop a technology for detecting a fluorescent layer and adjusting or controlling optical property of the fluorescent layer.

### SUMMARY OF THE INVENTION

The present invention provides a detection system for detecting a fluorescent layer on an object, so as to control optical property of the fluorescent layer.

In accordance with the present invention, the detection system for detecting a fluorescent layer formed in a fluorescent layer forming system includes a light source module, a light detecting module and a light transmitting module, wherein the light source module emits a detecting light to a fluorescent layer, the detecting light is then converted by the fluorescent layer to a light to be detected, the light to be detected is received by the light detecting module, and detection data are formed. In addition, the transmission of the detecting light and the light to be detected are performed by the light transmitting module.

In an embodiment of the present invention, the detection system further includes a processing module for receiving the detection date from the light detecting module, and transmitting a control instruction according to the detection data to control the system in which the fluorescent layer is formed.

In another embodiment of the present invention, the light transmitting module includes an optical fiber and a beam splitter disposed on transmission paths of the detecting light and the light to be detected for transmitting the detecting light to the optical fiber and transmitting the light to be detected from the optical fiber via the beam splitter to the light detecting module.

In another embodiment of the present invention, the light transmitting module includes a first optical fiber for transmitting the detecting light to the fluorescent layer and a second optical fiber for transmitting the light to be detected to the light detecting module.

In another embodiment of the present invention, the system in which the fluorescent layer is formed includes a carrier for an object disposed thereon, and the fluorescent layer is formed on the object. In accordance with the present invention, the carrier has a carrying plane for the object disposed thereon and a back plane, wherein transmission paths of the detecting light and the light to be detected are disposed at the same side as the carrying plane. In a preferred embodiment of the present invention, the carrier is transparent, the fluorescent layer is formed on the carrying plane, and transmission paths of the detecting light and the light to be detected are disposed at the side of the back plane and through the carrier.

In comparison with the prior art, the present invention provides a detection system for detecting a fluorescent layer formed in a system via a detection of light, so as to determine whether the property of the fluorescent layer meets the standard. Further, the control of the fluorescence powder source in the fluorescent layer forming system is performed according to the detection result of the detection system of the present invention. Therefore, chromaticity and optical property of the fluorescent layer can be controlled and monitored.

### BRIEF DESCRIPTION OF THE DRAWINGS

FIG. 1A and FIG. 1B show the distribution of fluorescent powders in the conventional LED package;

FIG. 2 is a schematic view showing the operation of the detection system according to the present invention;

FIG. 3 is a schematic view showing the detection system according to the embodiment of the present invention;

FIG. 4 is a schematic view showing the light transmission path of the detection system according to the present invention;

FIG. 5 is a schematic view showing another light transmission path of the detection system according to the present invention;

FIG. 6 is a schematic view showing the detection system of the present invention applied in a fluorescent layer forming system according to an embodiment of the present invention;

FIG. 7 is a schematic view showing the detection system of the present invention applied in a fluorescent layer forming system according to another embodiment of the present invention; and

FIG. 8 is a flow chart showing the coating sequence according to the present invention.

### DETAILED DESCRIPTION OF THE PREFERRED EMBODIMENTS

The following specific examples are used for illustrating the present invention. A person skilled in the art can easily conceive the other advantages and effects of the present invention.

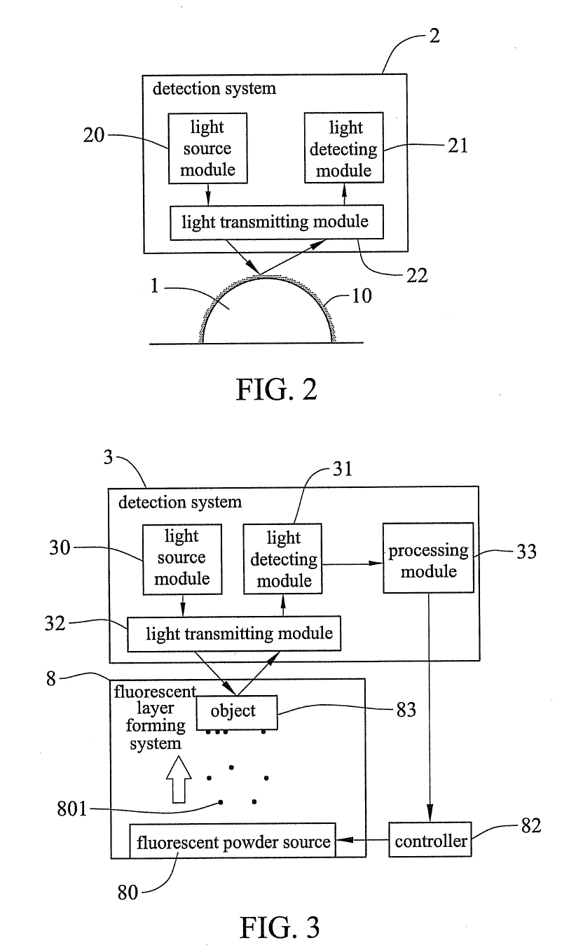

FIG. 2 is a schematic view showing the operation of the detection system according to the present invention. A detection system 2 is used for detecting a fluorescent layer 10 on an object 1 and determining whether the fluorescent layer 10 meets the standard. The detection system 2 includes a light source module 20, a light detecting module 21 and a light transmitting module 22.

The light source module 20 emits a detecting light via the light transmitting module 22 to the fluorescent layer 20 on the object 1, and the detecting light is converted by the fluorescent layer 10 into a light to be detected. The light to be detected is received by the light detecting module 21 via the light transmitting module 22, and detection data are produced by measuring the light to be detected. The detection data include a chromaticity coordinate, and then it is to be determined whether the fluorescence layer 10 meets the requirement.

In the detection system 2, the light source module 20 may be a light emitting diode such as a blue LED, and the fluorescent layer 10 is made of fluorescent particles by electrostatic attraction. If the fluorescent particles are yellow, the light converted by the fluorescent layer 100 is white light. In accordance with the present invention, a detection data bank is established, and the detection data bank includes various chromaticity data corresponding to time for forming the fluorescent layer or the stacking speed of the fluorescent particles.

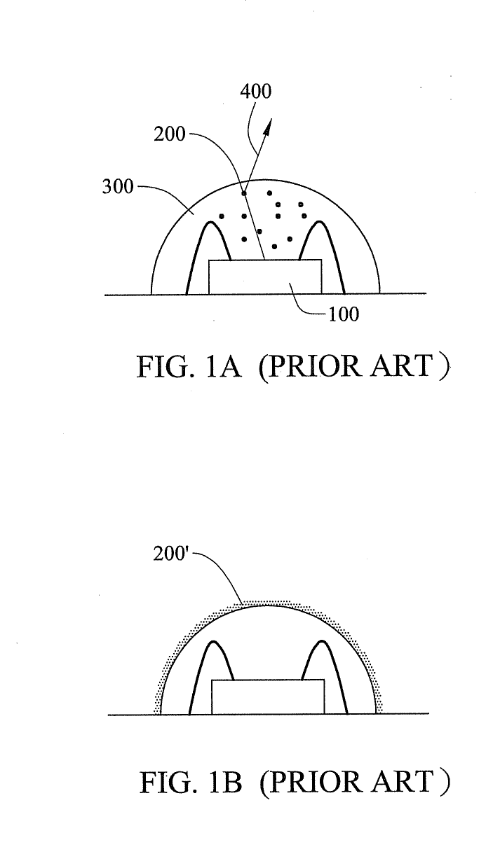

FIG. 3 is a schematic view showing the detection system according to the embodiment of the present invention. A detection system 3 is used for detecting a fluorescent layer 10 on an object 83 in a fluorescent layer forming system 8. A light source module 30, a light detecting module 31 and a light transmitting module 32 in the detection system 3 are similar to those shown in FIG. 1 except that the detection system 3 further includes a processing module 33.

The processing module 33 is used for receiving detection data from the light detecting module 31, and transmitting a control instruction according to the detection data to control the fluorescent layer forming system 8. Specifically, the detection data is received the light detecting module 31 so as to obtain the formation status of the fluorescent layer 10, and then the fluorescent layer forming system 8 is controlled according to the detection data. For example, a determination is made and then a control instruction is provided by the processing module 33, and then the fluorescent powder source 80 in the fluorescent layer forming system 8 is controlled by a controller 82, so as to control the supply, such as speed, of the fluorescent particles 801. The controller 82 may be disposed in or outside the fluorescent layer forming system 8 for controlling the fluorescent powder source 80. The fluorescent layer forming system 8 is controlled to continue or stop forming the fluorescent layer according to the real time detection from the detection data bank of the detection system of the present invention.

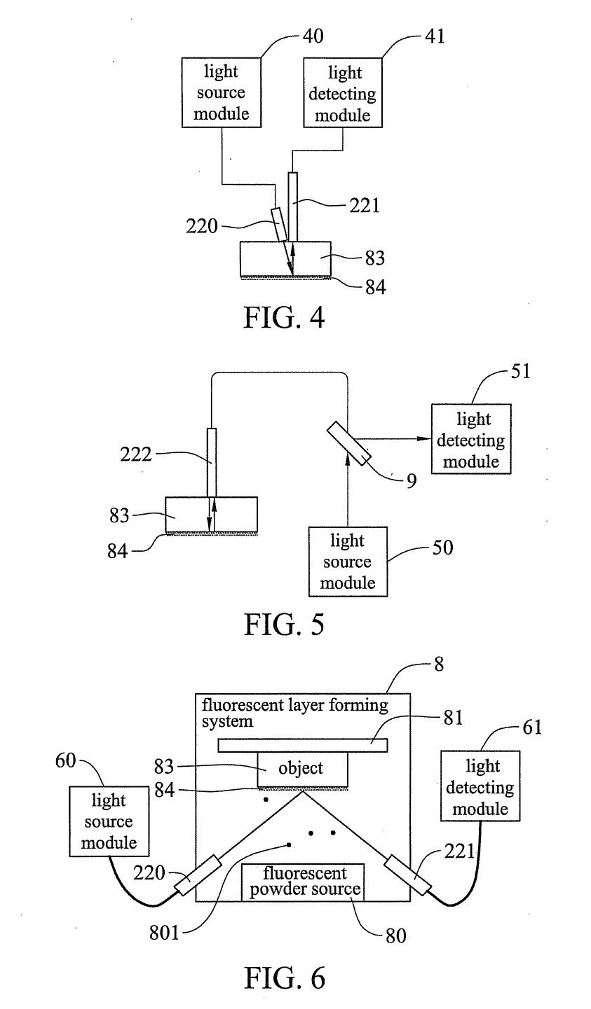

FIG. 4 is a schematic view showing the light transmission path of the detection system according to the present invention. As shown in FIG. 4, the light transmitting module includes a first optical fiber 220 for transmitting the detecting light to the fluorescent layer 84, and a second optical fiber 220 for transmitting the light to be detected to the light detecting module 41. The light can be transmitted by the optical fibers. For example, the detecting light emitting from the light source module 40 is transmitted to an object 83 via the first optical fiber 220, passes through the object 83 to the fluorescent layer 84, and is reflected by the fluorescent layer 84 into the light to be detected. The light to be detected passes through the object 83, and then is transmitted by the second optical fiber 221 to the light detecting module 41. The first optical fiber 220 and the second optical fiber 221 are used for preventing the light transmission from being influenced by other light.

FIG. 5 is a schematic view showing another light transmission path of the detection system according to the present invention. As shown in FIG. 5, only one optical fiber is used for light transmission. The light transmitting module includes an optical fiber 222 and a beam splitter 9 disposed on transmission paths of the detecting light and the light to be detected for transmitting the detecting light to the optical fiber 222 and transmitting the light to be detected from the optical fiber 222 via the beam splitter 9 to the light detecting module 51. In an embodiment of the present invention, the detecting light emitting from the light source module 50 passes through the beam splitter 9, then is transmitted by the optical fiber 222 to the object 83, passes through the object 83 to the fluorescent layer 84, and then is converted by the fluorescent layer 84 into the light to be detected. The light to be detected is transmitted by the optical fiber 222 to the beam splitter 9. A part of the light to be detected is reflected by the beam splitter 9 and then received by the light detecting module 51.

FIG. 4 and FIG. 5 provide different transmission paths of light for detecting the formation status of the fluorescent layer 84. The detection system of the present invention may obtain the detection data in response to corresponding angles of light according to various requirements.

FIG. 6 is a schematic view showing the detection system of the present invention applied in a fluorescent layer forming system according to an embodiment of the present invention. As shown in FIG. 6, a fluorescent layer forming system 8 includes a carrier 81 for an object disposed thereon and a fluorescent powder source 80, wherein the fluorescent layer 84 is formed on the object 83. The fluorescent powder source 80 provides fluorescent particles 801 to form the fluorescent 84 on the surface of the object 83. In this embodiment, the carrier 81 has a carrying plane for the object 83 disposed thereon and a back plane opposing to the carrying plane, wherein the transmission paths of the detecting light and the light to be detected are disposed at the same as the carrying plane. The detecting light transmitting from the light source module 60 is transmitted via the first optical fiber 220 to the fluorescent layer 84, then is converted by the fluorescent layer 84 into the light to be detected, and is transmitted by the second optical fiber 221 to the light detecting module 61.

The embodiment in FIG. 6 differs from the embodiments in FIG. 4 and FIG. 5 in that the transmission paths of the detecting light and the light to be detected are formed without passing through the object.

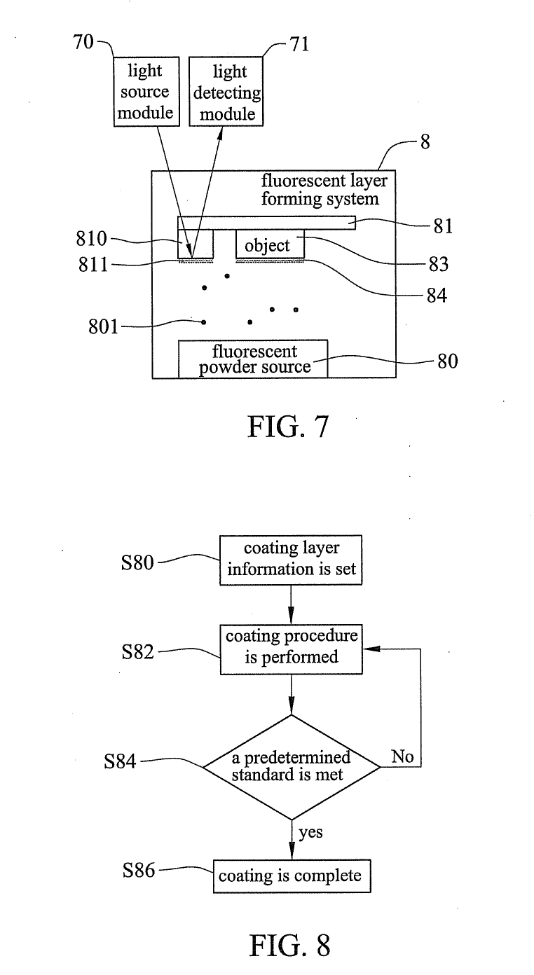

FIG. 7 is a schematic view showing the detection system of the present invention applied in a fluorescent layer forming system according to another embodiment of the present invention. As shown in FIG. 7, a fluorescent layer forming system 8 includes a carrier 81 for an object disposed thereon and a fluorescent powder source 80, wherein the carrier 81 is made of a transparent material such as a glass or quartz. The carrier 81 has a carrying plane for the object disposed thereon and a back plane opposing to the carrying plane, a detection area 810 is formed at the same side as the carrying plane of the carrier 81 and disposed near the object 83, such that the fluorescent powder source 80 provides the fluorescent particles 801 to form a fluorescent layer 84 on the object 83 and also form a fluorescent layer 811 on the detection area 810.

The detecting light emitting from the light source module 70 passes through the transparent material to the fluorescent layer 811, and then is converted by the fluorescent layer 811 into the light to be detected. The light to be detected is transmitted to the light detecting module 71. Since the formation conditions of the fluorescent layer 811 and the fluorescent layer 84 are similar, the detection data of the fluorescent layer 811 may indicate the formation status of the fluorescent layer 84. In this embodiment, the transmission paths of the detecting light and the light to be detected are disposed at the same side as the back plane of the carrier 81, and the detecting light and the light to be detected pass through the carrier 81. Since the detecting light and the light to be detected are transmitted without passing between the fluorescent powder source 80 and the object 83, the detecting light and the light to be detected are not influenced by the depositing fluorescent particles 801 and thus the detection data are accurate.

Referring to FIG. 8 and FIG. 3, the coating sequence in the present invention is illustrated. As shown in FIG. 8, in the step S80, the coating layer information such as the speed, amount or time for providing the fluorescent particles from the fluorescent powder source is set.

In the step S82, a coating procedure is performed. The coating sequence is performed in the fluorescent layer forming system to form a fluorescent layer on the object.

In the step S84, it is determined whether the fluorescent layer meets the standard. It is determined by using the detecting light whether the fluorescent layer meets the predetermined standard. If the fluorescent layer fails to meet the predetermined standard, the procedure returns to the step S82. If the fluorescent layer meets the predetermined standard, the step S86 is performed, i.e. the coating is complete.

In comparison with the prior art, the present invention provides a detection system for detecting a formation status of a fluorescent layer so as to determine whether the fluorescent layer formed on an object in a fluorescent layer forming system meets a predetermined standard. Further, in the present invention, a fluorescent powder source in the fluorescent layer forming system is controlled according to the detection data, such that quality of the object in each fabrication is consistent. Hence, the detection system of the present invention can be used in a large scale production and can be customized according to various requirements.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. A detection system for detecting a fluorescent layer formed in a fluorescent layer forming system, comprising:
a light source module for emitting a detecting light to a fluorescent layer, wherein the detecting light is then converted to a light to be detected;
a light detecting module for receiving the light to be detected and producing detection data in response to the light to be detected; and
a light transmitting module for transmitting the detecting light to the fluorescent layer and transmitting the light to be detected to the light detecting module.

2. The detection system of claim 1, wherein the light source module is a light emitting diode.

3. The detection system of claim 1, wherein the detection data include a chromaticity coordinate.

4. The detection system of claim 1, further comprising a processing module for receiving the detection data from the light detecting module, and transmitting a control instruction according to the detection data to control the fluorescent layer forming system.

5. The detection system of claim 1, wherein the light transmitting module comprises an optical fiber and a beam splitter disposed on transmission paths of the detecting light and the light to be detected for transmitting the detecting light to the optical fiber and transmitting the light to be detected from the optical fiber via the beam splitter to the light detecting module.

6. The detection system of claim 1, wherein the light transmitting module comprises a first optical fiber for transmitting the detecting light to the fluorescent layer and a second fiber for transmitting the light to be detected to the light detecting module.

7. The detection system of claim 1, wherein the fluorescent layer forming system comprises a carrier for an object, and the fluorescent layer is formed on the object.

8. The detection system of claim 7, wherein the carrier has a carrying plane for the object to be disposed thereon, and transmission paths of the detecting light and the light to be detected are disposed at the same side as the carrying plane.

9. The detection system of claim 7, wherein the carrier is transparent and has a back plane opposing to the carrying plane, the fluorescent layer is formed on the carrying plane of the carrier, and transmission paths of the detecting light and the light to be detected are disposed at the same side as the back plane and through the carrier.

10. The detection system of claim 9, wherein the carrier is a glass or quartz.
